(19) United States
(12) Patent Application Publication
(10) Pub. No.: US 2026/0145889 A1
(43) Pub. Date: May 28, 2026

(54) METHOD OF LOGISTICS PLANNING USING SPECIALIZED EQUIPMENT

(71) Applicant: Communications Test Design, Inc., West Chester, PA (US)

(72) Inventors: Jerry PARSONS, West Chester, PA (US); Nidhin DAVIS, Glen Mills, PA (US); William KNOTT, Glen Mills, PA (US); Nazariy KMET, Jamison, PA (US); Jaclyn DOMSOHN, Downingtown, PA (US); Ritvik TIWARI, King Of Prussia, PA (US); Siddharth MAHESHWARI, King Of Prussia, PA (US)

(73) Assignee: Communications Test Design, Inc., West Chester, PA (US)

(21) Appl. No.: 18/956,080

(22) Filed: Nov. 22, 2024

(51) Int. Cl. B65G 54/02; B65G 43/08

(52) U.S. Cl. CPC B65G 54/02; B65G 43/08

(57) ABSTRACT

A method of logistics planning using specialized equipment is shown and described. The method of logistics planning using specialized equipment starts by receiving scan results of an electronic device. The scan results include a damage report of the electronic device. The electronic device then enters an electro-magnetic moving table. The electronic device is placed on a magnetic mover. The first destination for the electronic device is determined. Once determined to be the next step the electronic device exits the electro-magnetic moving table.

### BACKGROUND OF THE INVENTION

Technology is always advancing and has done so at a rapid pace for the last several decades. Technology has become sophisticated, smaller, and accessible across the globe. This has led to technology becoming integral in everyday life. As with any integral element of life, the demand is high. This high demand has led to a rise in the cost of technological devices.

In addition to high demand, the simple replacement of devices can be expensive. If one merely discards older equipment or equipment with minor defects for a brand-new piece the cost can escalate quickly. If, however, technology is upgraded, or repaired this process can be much more cost effective for both the company and consumer.

It can be a logistical nightmare to receive electronic devices, grade these devices, and determine how best to refurbish and repair such devices. Some of the larger problems include human error, subjective decision making, and sheer volume of electronic devices to be assessed each day. Hundreds or thousands of electronic devices may be processed through one station in a given day. It is natural that mistakes will be made when assessing this sort of volume.

With current technology it is possible to automate such processes as grading and testing of certain functional features. The purpose of this invention is not to remove the human element but to remove mistakes and subjective decisions. Under the previous method of operation an individual will have to review the grade of a device, check for other damages, then decide where the device should go from there. Further, often when electronic devices undergo this process they must be sorted by type and placed into containers before going to the next station.

This means that there can be a significant delay between when an electronic device is brought into a facility and when it is ready to be resold. This is in part due to having to fill cases of electronic devices before moving them to the next part of the process to be refurbished. Not only can adding electronic devices to cases for movement take time, but it can also add additional issues to electronic devices. While many electronic devices are extremely robust, they can still suffer even small amounts of damage through this current process. This damage can subtract value from an electronic device.

Many companies have been taking advantage of the repair instead of discard philosophy. Further, many consumers are happy purchasing a lightly used and repaired device instead of a brand new one. However, these processes come with new challenges in order to remain effective. Consequently, there is always a need for an improvement in the art.

### SUMMARY OF THE INVENTION

The present invention provides a method of logistics planning using specialized equipment wherein the same can be utilized for providing enhanced logistics and remove subjective decision making and mistakes from the processes in which it is used. The method of logistics planning using specialized equipment starts by receiving scan results of an electronic device. The scan results include a damage report of the electronic device. The electronic device then enters an electro-magnetic moving table. The electronic device is placed on a magnetic mover. The first destination for the electronic device is determined. Once determined to be the next step the electronic device exits the electro-magnetic moving table. The method of logistics planning using specialized equipment of claim 1 further comprising moving the electronic device to the first destination.

Another object of the method of logistics planning using specialized equipment is to perform a first action on the electronic device.

Another object of the method of logistics planning using specialized equipment is to determine a second destination for the electronic device.

Another object of the method of logistics planning using specialized equipment is to have the first action be a test performed on the electronic device and the second destination is at least partially determined by results if the first test.

Another object of the method of logistics planning using specialized equipment is to move the electronic device to the second destination.

Another object of the method of logistics planning using specialized equipment is to performing a second action on the electronic device.

Another object of the method of logistics planning using specialized equipment is to determine an ID of the electronic device.

Another object of the method of logistics planning using specialized equipment is to assign the ID to a magnetic mover.

Another object of the method of logistics planning using specialized equipment is to have the electronic device enter the electro-magnetic moving table and be placed on a magnetic mover.

Another object of the method of logistics planning using specialized equipment is to move the electronic device on the electro-magnetic moving table.

Another object of the method of logistics planning using specialized equipment is to have the method of moving the electronic device include the steps of:
determining a destination of the electronic device;
determining the destination availability;
assigning the electronic device to the destination;
moving the device to the destination.

Another object of the method of logistics planning using specialized equipment is to have the steps of determining a destination of the electronic device and determining the destination availability enter a loop until the destination is available.

Another object of the method of logistics planning using specialized equipment is to have the moving step further include the steps of:
checking the availability of a space adjacent to the electronic device;
moving to the adjacent space;
determining if the space is the destination space;
continuing this process until the electronic device is at the destination.

Another object of the method of logistics planning using specialized equipment is to have the availability of multiple spaces be determined before the electronic device is moved.

Another object of the method of logistics planning using specialized equipment is to have the electronic device only move in a single direction around the electro-magnetic moving table.

Another object of the method of logistics planning using specialized equipment is to scan the electronic device for device defects.

Another object of the method of logistics planning using specialized equipment is to assign a grade to the electronic device based on the scan of the electronic device.

Another object of the method of logistics planning using specialized equipment is to have the destination of the electronic device be determined at least in part by the grade of the electronic device.

Other objects, features and advantages of the present invention will become apparent from the following detailed description taken in conjunction with the accompanying drawings.

### BRIEF DESCRIPTION OF THE DRAWINGS

The accompanying drawings are incorporated in and are to be considered part of the present specification. These drawings are meant to aid the reader's understanding and comprehension of the present disclosure and are depictions of various example embodiments. The drawings are not to be considered limiting upon the disclosure. It should specifically be noted that the drawings are examples and may not necessarily be drawn to scale.

FIG. 1 shows a block diagram of a computing system.

FIG. 2A shows a front view of an example of a mobile phone device.

FIG. 2B shows a rear view of an example of a mobile phone device.

FIG. 3 shows a perspective view of an embodiment of specialized equipment for the method.

FIG. 4 shows a top-down view of an embodiment of the mover for the specialized equipment.

FIG. 5 shows a top-down view of an embodiment of the electronic device positioning device.

FIG. 6 shows a flow chart of an embodiment of a logistics method for managing intake and refurbishment of electronic devices.

FIG. 7 shows a flow chart for an embodiment of a more detailed part of the method for managing intake and refurbishment of electronic devices.

FIG. 8 shows a flow chart for an embodiment of a more detailed part of the method for managing intake and refurbishment of electronic devices.

### DETAILED DESCRIPTION OF THE INVENTION

For the purposes of presenting a brief and clear description of the present invention, a preferred embodiment will be discussed as used for the method of logistics planning using specialized equipment. The figures are intended for representative purposes only and should not be considered to be limiting in any respect.

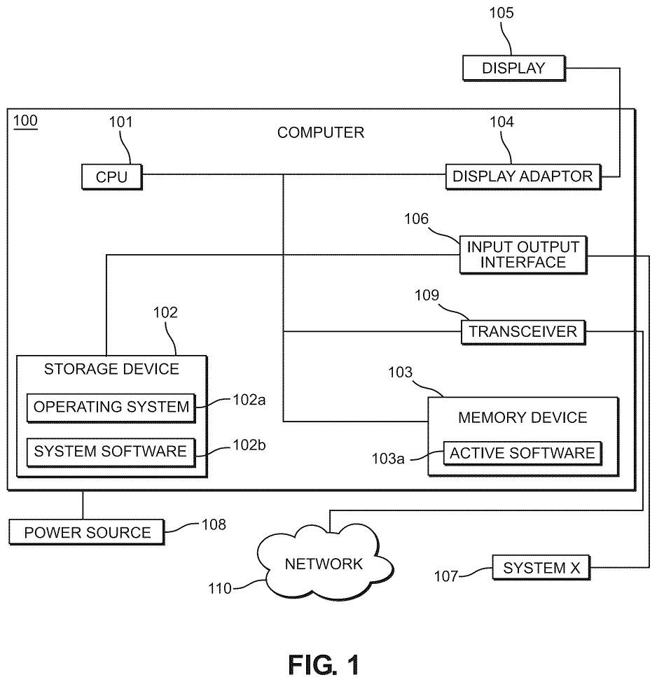

Referring now to FIG. 1, there is shown a block diagram of a computing system. Computing systems may have many interchangeable parts or multiples of some parts. One of ordinary skill in the art will understand that the shown computer 100 is a basic computing system demonstrating a minimal amount of parts to allow for the computer to function. Computer 100 is exemplary, and one of ordinary skill in the art will recognize that computer 100 may be altered as necessary to render the presently disclosed system operable or to provide a peak performance of the disclosed system.

The parts described are each operably coupled together as necessary, one of ordinary skill in the art will understand how to connect general computer components, for example by use of a mother board or other computer board. In the shown embodiment the computer 100 includes a CPU 101. In one embodiment the CPU 101 includes only one processor. In other embodiments the CPU 101 may be made up of multiple processors. Different processors will allow for different computing power and speed.

The computer 100 includes at least one storage device 102. In different embodiments the at least one storage device 102 may be a solid-state storage device, a disk storage device, or another suitable storage device. One of ordinary skill in the art will recognize that there are several types of computing storage devices each providing well-known benefits and drawbacks. The at least one storage device 102 will store at least the computer operating system 102a and system software 102b. System software 102b may include any software necessary, or optionally, used to run any system described herein.

The computer 100 will have at least one memory device 103. One of ordinary skill in the art will recognize that there are several types of computing memory devices each providing well known benefits and drawbacks. The at least one memory device 103 will store at any active software 103a. Active software 103a may include the operating system 102a or parts of the system software 102b. The at least one memory device 103 may store the entire system software 102b size and speed permitting.

The computer 100 may also include various connection ports and types. The computer 100 may have a display adaptor 104. The display adaptor 104 will allow the computer 100 to connect to at least one display 105. In other embodiments multiple displays may be connected to the display adaptor 104. Similarly, the computer 100 may include at least one input/output interface 106. The input/output interface 106 will allow the computer 100 to connect to at least one system, referred to as System X 107 in FIG. 1. The input/output interface 106 may also allow for connection to only part of System X 107 or multiple systems. The computer 100 will also be operably connected to a required power source 108.

The computer 100 may also include a transceiver 109. In one embodiment the transceiver 109 is a wired transceiver. In another embodiment the transceiver 109 is a wireless transceiver. The transceiver 109 will allow the computer 100 to connect to a network 110. The network 110 may be an internet or an intranet connection. The network 110 will allow for the computer 100 to potentially connect to multiple other computing devices. In another embodiment the network may allow for the computer 100 to connect to multiple systems. In one embodiment the computer 100 will allow for System X 107 to be connected to the network 110.

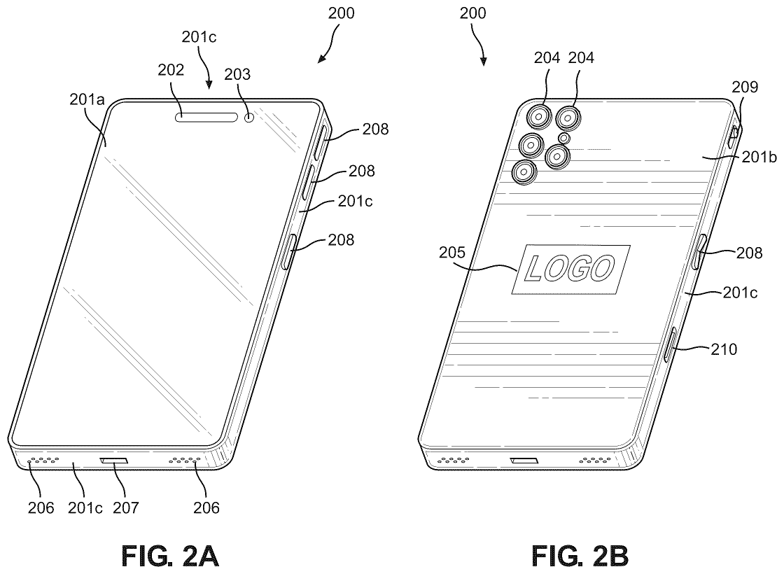

Referring now to FIG. 2A and FIG. 2B, there is shown a front view and a rear view of an example of an electronic device 200, such as a mobile phone device. Electronic devices may have many different parts and components. Even like parts or components may be in various locations or have different shapes and sizes. One of ordinary skill in the art will understand that the shown electronic device 200 is merely an example of the exterior of a device. Any specialized or specific features or requirements of devices will be detailed herein as necessary. However, one of ordinary skill in the art will understand that many electronic devices 200 have many of these described characteristics. Further, electronic devices, such as mobile phone devices, operate on a computer-based platform having many of the computer parts as described in FIG. 1. The below description seeks to detail external components and not the computer which runs the electronic device 200. The electronic device 200 can be, without limitation, a mobile phone device, or a tablet. In one embodiment other electronic devices may be used such as laptops, cable set top boxes, routers, or antennas.

The shown electronic device 200 includes a front surface 201a, a rear surface 201b, and four side surfaces 201c. The front surface 201a typically includes a screen which covers a majority of the surface. The screen is typically covered with a specialized material, currently a glass product. The front surface 201a may also include a speaker opening 202 and a camera opening 203.

The rear surface 201b of the electronic device 200 may include at least one camera lens 204. In the shown embodiment there are a plurality of camera lenses 204. In another embodiment at least one light lens is secured to the rear surface 201b. In many embodiments the rear surface 201b includes a logo 205. The logo 205 may represent the company which created the electronic device 200. The rear surface 201b may include a coating or covering to decorate or protect the rear surface. For example, a coating may be applied to the rear surface 201b to ensure a shiny surface.

The side surfaces 201c of the electronic device 200 may include any or all of the following parts. In one embodiment the electronic device 200 will have several openings for speaker output 206. The electronic device 200 will also include a charging port 207. Charging ports 207 may include a prong therein to secure to a charging cord. An electronic device 200 may include a plurality of buttons 208 along the side surfaces 201c. In different embodiments the plurality of buttons 208 may allow for volume control, locking the electronic device 200, or other desired functions. In some embodiments the electronic device 200 may include a switch 209. In yet another embodiment the electronic device 200 includes a SIM card slot or other card slot 210.

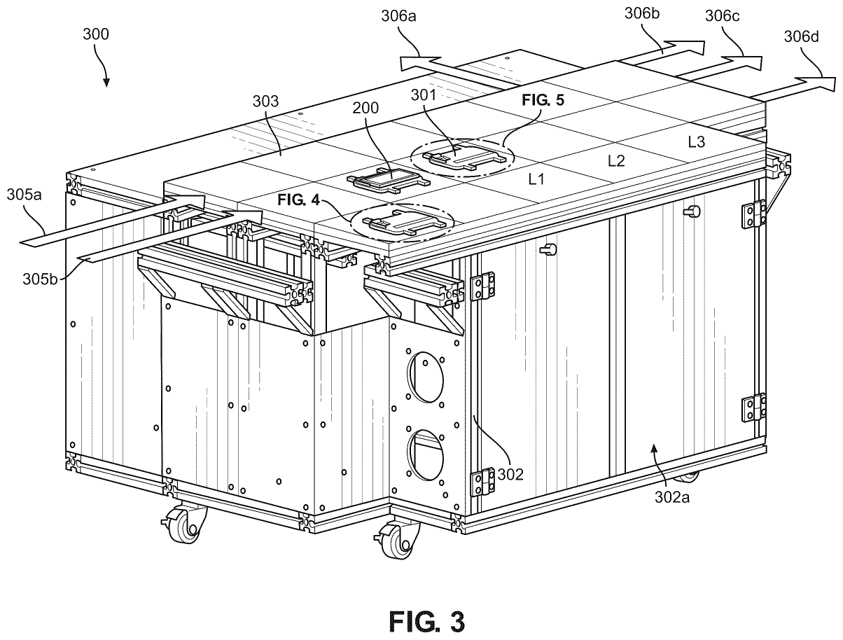

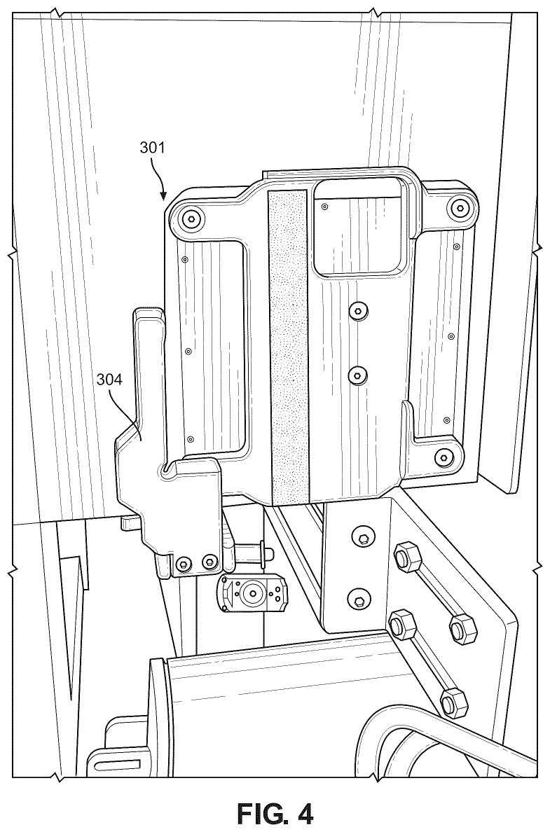

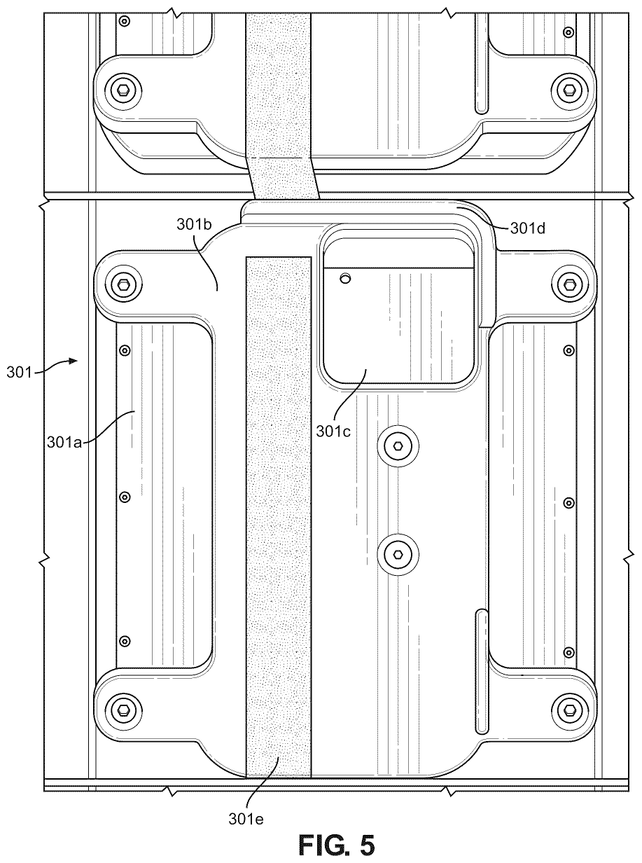

Referring now to FIG. 3, there is shown a perspective view of an embodiment of specialized equipment for the method. Additionally, FIG. 4 and FIG. 5 show enlarged top-down views of the devices in the callouts of FIG. 3. The method which will be described in more detail below can be used in a variety of different ways and one a variety of different equipment. However, the method works best on an electro-magnetic moving table 300. An electro-magnetic moving table 300 when using magnetic movers 301 will allow for custom movements and placement of electronic devices 200 which cannot be easily achieved by conveyors or similar transport machines.

The electro-magnetic moving table 300 includes a frame 302 which supports at least one electro-magnetic tabletop 303. In one embodiment the electro-magnetic tabletop 303 is made up of a plurality of parts. The electro-magnetic tabletop 303 creates an electromagnetic field which will raise the movers 301 and transport them around the tabletop 303.

The frame 302 creates a cabinet 302a under the tabletop 303. The cabinet 302 houses various electronic components such as the computer described in FIG. 1. Other examples of electronic components include power supplies, servers, cooling equipment, compressors, and actuators. One of ordinary skill in the art will be able to determine what electronic components are necessary for the table to function and be able to perform the method. In some embodiments the electronic components will be operably coupled to those of the electro-magnetic moving table 300. These electronic components can share information as dictated by the needs of the method.

In different embodiments different electronic devices may be transported using the described method and equipment. Callout 1 shows an embodiment of a magnetic mover 301. The magnetic mover 301 includes a magnetic base 301a which is configured to work with and move along the electro-magnetic tabletop 303 as instructed. Different size magnetic movers 301 may be used while still accomplishing the desired results. The magnetic mover 301 has a bracket 301b secured to a topside thereof. The shown bracket 301b is for an electronic device such as a phone. The bracket 301b includes a cutout 301c for camera lenses. The bracket 301b also includes at least one edge 301d which is designed to engage the edges of the electronic device and prevent it from sliding from the bracket 301b. In one embodiment the bracket 301b includes at least one strip of material 301e which will increase the friction between an electronic device and the bracket 301b.

In one embodiment electronic devices must be placed within the brackets 301b with precision. This can be complicated if not impossible even with modern machine and computers. In these embodiments an electronic device can be properly positioned on the bracket 301b using a positioning device 304. The positioning device 304 can be used to push an electronic device such that it is properly positioned within the bracket 301b. In the shown embodiment the positioning device 304 is situated slightly above the magnetic mover 301 and the bracket 301b. This will allow for the magnetic mover 301 to move under the positioning device 304 and push the electronic device into a proper position on the bracket 301b.

While not pictured various devices and pieces of equipment may be placed around the table. For example, a measurement device may be placed around the table. Various electronic devices may be used to test various parts of any devices which are subject to the method. In addition, various conveyors or other types of movement devices may be placed around the electro-magnetic moving table 300 to either bring devices to the table or removed devices therefrom.

In many embodiments there can be multiple input locations 305a, 305b. The multiple input locations 305a, 305b allow for items to enter the electro-magnetic moving table 300 from multiple points on the table in addition to from multiple locations. In different embodiments these input locations 305a, 305b can come from various industrial items such as conveyor belts or robots. In other embodiments the input locations 305a, 305b could be a person manually placing a device on the electro-magnetic moving table 300.

Similarly, there may be a plurality of table exit locations 306a, 306b, 306c, 306d. These table exit locations can be accomplished in the same ways as the input locations. The exits can lead to many different locations such as external test locations, repair stations, or other areas and stations as deemed needed by the user.

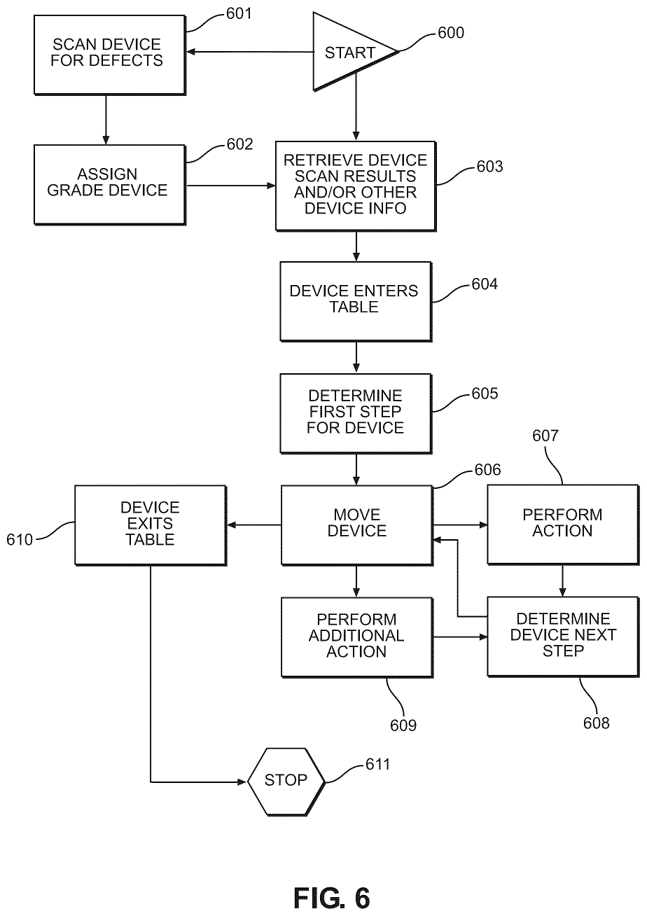

Referring now to FIG. 6, there is shown a flow chart of an embodiment of a logistics method for managing intake and refurbishment of electronic devices. In one embodiment the method starts 600 by scanning a device for defects 601. In different embodiments the scan may look for different types of defects. In one embodiment the scan will locate cosmetic blemishes. In one embodiment the scan will assign a grade to the device 602. In some embodiments the method skips this step and the device may be graded using different methods or parameters.

In other embodiments the method begins by retrieving scan results or other device information 603. In one embodiment the device information is retrieved by using a device ID or IMEI. In some embodiments this information is received via a scan from a bar code or QR code associated with the device. After the device information is received the device enters the table 604. In one embodiment when the device enters the table the device ID is associated with the mover which receives the device.

After the device enters the table 604 the first step for the device is determined 605. In some embodiments the device may have any number of first steps possible. In other embodiments each device enters the same first step. In one embodiment for example a device may undergo a scratch depth scan to determine the depth of scratches in a device screen. In another embodiment the device may be scheduled to leave the table immediately due to extensive damage. After the first step is determined 605 the device is moved 606. In one embodiment the device is moved to a table exit station and the device exits the table 610.

When a device exits the table 610 it may go to any number of stations. The device may be placed on a conveyor and immediately taken to a station or location as desired away from the table. In some embodiments the device destination may be determined based on only the device grade. In other embodiments the location may be determined by the device grade and additional information such as scratch depth and/or device model and color.

In one embodiment after the first step is determined 605 the device is moved 606 to a first location, for example L1. A first action can then be performed on the device 607. In this embodiment after the first action is performed the next step is determined 608 and the device is moved again 606. In one embodiment the device is moved from the table 610. In another embodiment the device is moved 606 to another location, for example L2, and another action is performed 609. In other embodiments instead of going to a location on the table the device may exit the table 610 and an action is performed 609 elsewhere, then the device reenters the table as needed 604. In some embodiments the device enters a cycle of moving 606, having a test run, and determining the next step 608 until the device meets the proper criteria to exit the table 610. Once the device exits the table the method stops 611.

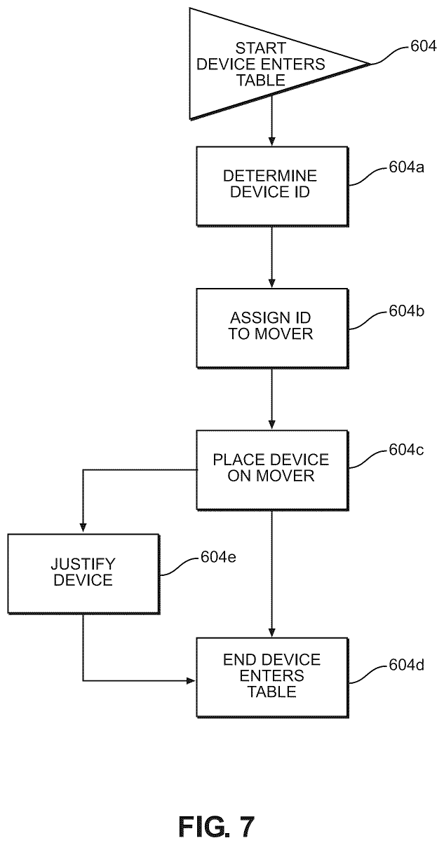

Referring now to FIG. 7, there is shown a flow chart for an embodiment of a more detailed part of the method for managing intake and refurbishment of electronic devices. In one embodiment the device enters the table 604 using a specific set of steps. The first step is determining the device ID 604a. The device ID may be a custom ID or the device ID may be something already associated with the device such as an IMEI. Once the device ID has been determined it can be assigned to a mover 604b. Once the device ID is assigned to the mover 604b the device can be placed on a mover 604c.

In one embodiment the device is considered properly on the table and the method ends 604d. In another embodiment the specific location of the device on the mover is important. In this embodiment the device must be properly placed or justified on the device mover 604e. In one embodiment this can be accomplished by pushing the device against the device positioner described above. After the device is justified 604e the method ends 604d.

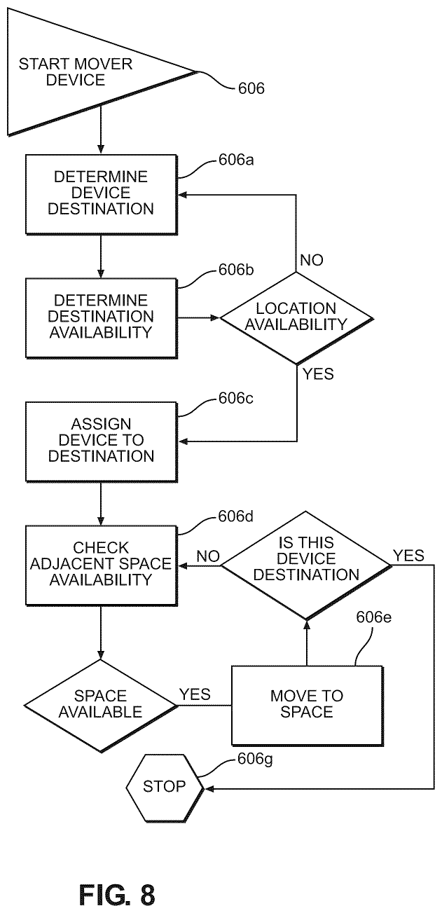

Referring now to FIG. 8, there is shown a flow chart for an embodiment of a more detailed part of the method for managing intake and refurbishment of electronic devices. When it is determined that a device needs to move for any reason, the device needs to move in such a way that it will not collide with other devices. In one embodiment this is accomplished by using the method as described. In some embodiments multiple computers are used to perform various methods described herein.

In one embodiment the use of multiple computers allows for one computer to control the specialized equipment and another computer to be used to run mover functions. It is not required that this division of computer labor be exact. However, this embodiment allows for cooperative multitasking. For example, during the method of moving a device as described below, each magnetic mover on the electro-magnetic moving table may run the same method simultaneously. This can create a more efficient table without the need for a linear method.

This method starts when it is determined that a device needs to move 606. The next step is to determine the device's ending destination 606a. After the ending destination is determined 606a the locations availability must be determined 606b. In one embodiment if the location is available, then the device is assigned to that destination 606c. In another embodiment if a location is available then a mover applies for that destination. In this embodiment the mover will then check to see if it won the space. This will set the location as occupied. If the location is not available, then the device destination is reevaluated. The device's destination is redetermined 606a. When this happens, a new destination may be determined for the device. This destination will be assigned based on the devices need and the destination availability. It is also possible in this instance that the same destination is kept, and the cycle will loop until a destination is made available.

After a destination is assigned to a device 606c the device begins the movement cycle. This cycle begins by checking the immediately adjacent space to determine availability 606d. In one embodiment the movement is restricted such that the devices can only move in one direction around the table. This prevents a backlog due to devices attempting to move in both directions. If the adjacent space is available then the device moves into that space 606e. In some embodiments the mover may check multiple spaces at once linking the movement together. This will allow for a mover to move multiple spaces at one time which can result in quicker movements. Once the mover enters the last space the system then checks to determine if this is the device's final destination. If this is the destination, then the movement method ends 606g. If it is not the final device destination, then the method cycle continues by checking the availability of the now adjacent space 606d. In some embodiments during this cycle the adjacent space will be occupied. When this happens, the system will enter a loop checking to see if the necessary space is available until it becomes available. Once available the mover moves to that space 606e.

In one embodiment as mentioned above multiple movers are running the method as described simultaneously. This will allow for constant motion of at least some of the movers on the electro-magnetic moving table. Further, this will allow for destinations and spaces to open up quicker because a mover will not have to wait for its place in line to be told to move. By using cooperative multitasking magnetic movers can be moved in a much quicker fashion.

It is therefore submitted that the methods, systems, and devices have been shown and described in what is considered the most practical and preferred embodiments along with specific examples. It is recognized, however, that departures may be made within the scope and these present examples are not intended to be limiting. One of ordinary skill the art will be able to discern that obvious modifications can be made without departing from the scope or spirit.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Similarly, it is to be realized that, it is not intended for any method set forth herein to be construed as requiring that its steps be performed in a specific order, unless otherwise set forth in the claims.

Therefore, the foregoing is considered as illustrative only of the principles of the disclosure. Further, since numerous modifications and changes will readily occur to those skilled in the art, it is not desired to limit the invention to the exact construction and operation shown and described, and accordingly, all suitable modifications and equivalents may be resorted to, are deemed to fall within.

What is claimed:

1) A method of logistics planning using specialized equipment, comprising:
receiving scan results of an electronic device, wherein the scan results include a damage report of the electronic device;
entering an electro-magnetic moving table by the electronic device, wherein the electronic device is placed on a magnetic mover;
determining a first destination for the electronic device;
exiting the electro-magnetic moving table by the electronic device.

2) The method of logistics planning using specialized equipment of claim 1 further comprising moving the electronic device to the first destination.

3) The method of logistics planning using specialized equipment of claim 2 further comprising performing a first action on the electronic device.

4) The method of logistics planning using specialized equipment of claim 3 further comprising determining a second destination for the electronic device.

5) The method of logistics planning using specialized equipment of claim 4 wherein the first action is a test performed on the electronic device and the second destination is at least partially determined by results if the first test.

6) The method of logistics planning using specialized equipment of claim 4 further comprising moving the electronic device to the second destination.

7) The method of logistics planning using specialized equipment of claim 6 further comprising performing a second action on the electronic device.

8) The method of logistics planning using specialized equipment of claim 1 further comprising determining an ID of the electronic device.

9) The method of logistics planning using specialized equipment of claim 8 assigning the ID to a magnetic mover.

10) The method of logistics planning using specialized equipment of claim 1 wherein when the electronic device enters the electro-magnetic moving table it is placed on a magnetic mover.

11) The method of logistics planning using specialized equipment of claim 1 further comprising moving the electronic device on the electro-magnetic moving table.

12) The method of logistics planning using specialized equipment of claim 11 wherein the method of moving the electronic device is comprising the steps of:
determining a destination of the electronic device;
determining the destination availability;
assigning the electronic device to the destination;
moving the device to the destination.

13) The method of logistics planning using specialized equipment of claim 11, wherein the steps of determining a destination of the electronic device and determining the destination availability enter a loop until the destination is available.

14) The method of logistics planning using specialized equipment of claim 11, wherein the moving step is comprised of checking the availability of a space adjacent to the electronic device;
moving to the adjacent space;
determining if the space is the destination space;
continuing this process until the electronic device is at the destination.

15) The method of logistics planning using specialized equipment of claim 14, wherein the availability of multiple spaces is determined before the electronic device is moved.

16) The method of logistics planning using specialized equipment of claim 1, wherein the electronic device can only move in a single direction around the electro-magnetic moving table.

17) The method of logistics planning using specialized equipment of claim 1 further comprising scanning the electronic device for device defects.

18) The method of logistics planning using specialized equipment of claim 1, wherein the device may enter the table from any one of a multitude of predetermined input locations.
